(19) United States
(12) Patent Application Publication
(10) Pub. No.: US 2011/0085141 A1
(43) Pub. Date: Apr. 14, 2011

(54) System for the projection of stereoscopic motion pictures

(76) Inventors: Lenny Lipton, Los Angeles, CA (US); Albert L. Mayer, JR., Thousand Oaks, CA (US); John A. Rupkalvis, Burbank, CA (US)

(21) Appl. No.: 12/802,787

(22) Filed: Jun. 14, 2010

Related U.S. Application Data
(60) Provisional application No. 61/269,085, filed on Jun. 19, 2009.
(60) Provisional application No. 61/335,535, filed on Jan. 8, 2010.
(60) Provisional application No. 61/339,271, filed on Mar. 1, 2010.

(51) Int. Cl. G03B 35/26; G03B 35/18

(52) U.S. Cl. 352/40; 352/60

(57) ABSTRACT

A system for projecting stereoscopic images is provided. The system includes a light source configured to provide light energy to a length of film having frames each comprising two sideframes oriented off axis, or side-by-side, from a preferred viewing orientation, an image receiving lens configured to receive light energy transmitted through the length of film, and an optical arrangement configured to receive images as light energy from the image receiving lens. The optical arrangement may include an afocal extender and means for reorienting images to the preferred viewing orientation and registering images reoriented to the preferred viewing orientation to a screen. The means for reorienting and registering include a plurality of optical refractive elements. Polarization, such as linear polarization, may be employed.

This application claims the benefit of (1) U.S. Provisional Patent Application Ser. No. 61/269,085, entitled “System for the Projection of Stereoscopic Motion Pictures”, inventor Lenny Lipton, filed on Jun. 19, 2009, (2) U.S. Provisional Patent Application Ser. No. 61/335,535, entitled “System for the Projection of Stereoscopic Motion Pictures”, inventors Lenny Lipton, et al., filed on Jan. 8, 2010, and (3) U.S. Provisional Patent Application Ser. No. 61/339,271, entitled “System for the Projection of Stereoscopic Motion Pictures”, inventors Lenny Lipton, et al., filed Mar. 1, 2010, the entirety of which are incorporated herein by reference.

### BACKGROUND OF THE INVENTION

1. Field of the Invention

The present invention relates to the art of stereoscopic motion picture projection, and more specifically, to enhanced designs for efficiently projecting stereoscopic motion pictures using film and linear polarization techniques.

2. Description of the Related Art

In recent years the stereoscopic cinema has enjoyed a renaissance based to a significant extent on electronic and digital technology. In particular, projection has profited from the fact that digital projectors, using devices such as the Texas Instruments DMD (Digital Micromechanical Device), have been well suited to the field-sequential or time-multiplex technique when used in conjunction with other selection techniques such as polarization. These projectors can rapidly change fields because of their short blanking interval. This allows the projectors to be used in the field-sequential mode (alternating between perspective views) which cannot tolerate long delays between fields. This coupled with a polarizing modulator, such as the ZScreen, allows successive fields to be encoded with polarization—in particular, circular polarization. When a polarization-conserving projection screen is used in conjunction with this kind of projection and the audience members are equipped with proper analyzing eyewear, a good-quality stereoscopic image can be observed.

Production techniques are also an important part of the filmmaking manufacturing process. The most developed portion of the stereoscopic motion picture image-generation infrastructure is computer-generated animation. Computer-generated animation technicians and animators can deploy a dual headed stereoscopic virtual camera within their three-dimensional data base to capture the two perspective views that are required for stereoscopic imaging. Camera systems also depend on electronic and digital technology to film a stereoscopic image pair. Silver halide film technology, on the other hand, precludes the content creator from observing the image while it is being created, or from readily manipulating the image in post-production. Electronic imaging overcomes such difficulties, allowing for instant viewing and manipulation of the stereoscopic image. In the past stereoscopic film projection has not allowed for the development of foolproof products.

The digital or electronic pipeline that is part of the motion picture manufacturing process is a crucial element in the success of the stereoscopic cinema. Heretofore, optical printing techniques would have been required to rectify asymmetries or correct mistakes that were created in the camera. As is known, every optical printing technique introduces another “generation,” in filmmaking parlance, and a corresponding reduction in image quality. But as far as electronic or digital post production techniques are concerned, manipulations that are either achievable optically or would have been impossible using conventional photography procedures are readily accomplished. Moreover, such manipulations do not degrade image quality.

In this day and age, the entire infrastructure for manufacturing stereoscopic film could benefit greatly by being electronic, including capturing, post production, and projection. For the first two categories this is correct, but as far as projection is concerned, there are overwhelming business and technology advantages to retaining and adapting 35 mm projection for stereoscopic projection.

The present design addresses prior limitations for projection of stereoscopic motion pictures since both digital and film projection have shortcomings.

Although the stereoscopic cinema is, as noted, gaining a foothold, and is for the first time, it would appear, headed for widespread adoption, there are several factors that inhibit its acceptance. Digital cinema projectors are costly. At the present time, digital systems can cost over $50,000, and an exhibitor would be hard pressed to find a reason to purchase a digital projector were it not for the stereoscopic application. That is because, until the addition of the stereoscopic medium, it was hard to make a business case for a digital projector, because 35 mm projection is so good and digital projection, arguably, provides no better image quality. While the vast majority of people cannot see the difference between good-quality 35 mm and good-quality digital projection, just about everybody can tell the difference between a 2D and 3D motion picture and can appreciate stereoscopic motion picture projection.

Because of various considerations including financial concerns, instead of projectors being deployed at the rate of thousands per year, projectors are now being deployed at the rate of hundreds per year. This greatly retards the acceptance of the stereoscopic cinema and imposes a financial burden on filmmakers and studios engaged in stereoscopic production, because revenue depends upon attendance and attendance depends on the number of stereo equipped theaters.

As of today, in North America, where there are about 40,000 screens, a major theatrical release requires upwards of 4,000 screens. There need to be in excess of 4,000 stereoscopic projectors, at least twice that number, so that two major features can be released at the same time. It is estimated that there are about 140,000 theater screens worldwide. There are far fewer actual venues showing stereoscopic films largely because of the practices employed in multiplex complexes. In multiplex theaters exhibitors practice “rotation,” which involves allocating appropriate numbers of seats in the complex based on the each movie's popularity. As one film wanes in popularity it is cycled into smaller theaters within the multiplex complex. The entire concept is one of “real estate”, of maximum utilization of seats.

Right now the stereoscopic cinema, because of the lack of digital projectors, does not allow the exhibitors to engage in the practice of rotation. There simply are not enough stereoscopic projection screens. This cuts into exhibitor and distributor revenue.

The vast majority of theaters in the United States and particularly in foreign countries continue to employ film (non-digital) projectors. Prior attempts to use 35 mm film projectors for stereoscopic exhibition has produced two distinct approaches. The introduction of stereoscopic projection in the United States took place at the 1939 World's Fair in Flushing Meadows Park, New York, with two 35 mm projectors running in interlock with polarizing filters in front of their lenses. A polarization-conserving screen was used, and everyone in the audience was equipped with polarizing analyzing spectacles. The method of polarization used was linear polarization. This technique of using dual projectors has persisted until recently in theme parks, where 70 mm projectors have usually been used. They are run in interlock, using the same kind of techniques as used in 1939, and this gives a bright, sharp picture. Linear polarization is used because it gives a good result and is inexpensive. The same system, using two 35 mm projectors, was used in the theatrical cinema for a year or two in the early 1950's.

But it was recognized that a dual-projection ensemble posed many problems because the two projectors had to run in a coordinated fashion, which is difficult to achieve in a typical cinema projection booth. Good engineering principles for projection were enunciated in Lipton's Foundations of the Stereoscopic Cinema (1982, Van Nostrand, N.Y.), and the book articulates for the first time in print the principle of binocular symmetries, which involves establishing specifications for the following entities: geometry, illumination, and time.

In the case of projection, the application of the binocular symmetries principle is roughly as follows: The images have to be more or less of the same brightness. If they are not, the result will be discomfort for audience members. In terms of the geometrical principle, the images have to be the same magnification. If one image is bigger than the other, for example, the result for audience members will also be discomfort. The temporal symmetry principle dictates that the two images must be projected within a certain specifiable tolerance in terms of projector shutter phase, or once again the result will be audience discomfort. These are simple examples of the principle of binocular symmetries, and they guide the design not only of projection but of the entire stereoscopic transmission system.

One problem with the digital projection of stereoscopic theatrical features is the issue of image “judder” related to temporal symmetry. All motion pictures captured at 24 frames per second exhibit motion judder, a perceptual artifact resulting from an insufficiently high image capture rate. This anomaly can be seen in scenes involving panning and rapid motion as a kind of jerkiness. The effect is exacerbated with DMD stereo projection because of the temporal asymmetry intrinsic to the projection of field-sequential stereo movies despite the fact that a very high repetition rate is used, for a total of 144 frames per second (each frame of the stereo pair, given 24 frames per second, is concatenated and repeated three times).

Another artifact is present due to the temporal asymmetry, namely one caused by the spurious temporal parallax generated by the lack of simultaneity in the projection of left and right fields, in connection with the horizontal velocity component of motion. The greater this horizontal component the more noticeable the artifact which can have the effect of adding or subtracting from the proper values of parallax thus exaggerating or diminishing the stereoscopic effect. The judder artifact is a first order artifact and often noticeable, but the spurious parallax is a second order effect and more difficult to notice because it is masked by extra-stereoscopic cues.

Usually these last two enumerated asymmetries can be eliminated in film projection because the images are projected simultaneously. In the past, interlocked 35 mm projectors have been used to project stereoscopic films. The inability of this approach to meet industry standards for reliability and quality is well known. All symmetries were violated one way or another during projection, leading to the failure of the stereoscopic cinema in the early 1950's when a large number of features were produced for theatrical release.

An attempt was made to place both images on a single piece of film to overcome the projection difficulties endemic to the 1950's effort. This was briefly employed in the early 1980's for films such as “Comin' At Ya”, “Jaws 3D”, and “Metal Storm”. The technology of that era proved to have practical difficulties as severe, in their own way, as those associated with the two-projector system of the early 1950's.

It was hoped that by placing both the left and right images in the standard 35 mm frame, the synchronization problems of the two-projector solution would be solved. In addition, using a single projector to project both images is less costly. The format that was used is depicted in FIG. 1, showing 35 mm film 101 with sprockets 105. Subframes 102 and 103 which make up a stereo-pair are deployed within the area of a standard frame. The subframes are separated by subframe frame line 104. ANSI/SMPTE 257-1998 describes this format, which is known as the above-and-below or over-and-under format.

FIG. 2 is from Condon's U.S. Pat. No. 4,235,503, and shows one kind of projection lens used for the above-and-below format. The subframes 102 and 103 from FIG. 1 correspond to Condon's 26 and 28. The projection lens consists of two lenses mounted in a single mount, one for imaging the top subframe and the other for image the bottom subframe. The two images are polarized and projected superimposed on the polarization conserving screen (not shown). But without regard to type of projection lens, be it Condon's split dual optics, or mirror boxes, and prismatic attachments, all of these efforts had one major problem in common based innately on the format design. It is difficult for the projectionist to tell the difference between frame line 105 and subframe frame line 104. Frequent mistakes were made in splicing reels of film together or in setting the frame line adjustment in the projector, resulting in pseudostereoscopic projection in which the right eye sees the left eye image and vice versa, thus destroying the stereoscopic effect. This mistake was made notwithstanding the fact that index marks were sometimes used to help identify the handedness of the subframes.

In addition, the subframes' area is not an efficient use of available film stock in terms of sharpness or brightness. The image area of each subframe must be reduced by a factor of approximately two, so care must be given to how the resultant area is allocated. The aspect ratio of the resultant subframe images is about 2.35:1, the standard for 'scope projection. The 1.85:1 aspect ratio is used as frequently, or perhaps even more frequently these days, since it is more closely compatible with TV set displays. That aspect ratio, called wide screen, is not well utilized by the subframe image area. Resultant loss of image area reduces image quality, primarily sharpness, and as importantly, image brightness, both a direct function of image area.

Thus in summary, while thousands of film projectors are currently deployed throughout the world and are showing 2D motion pictures, and the expense of digital projectors is relatively high, it could be advantageous to provide a 3D or stereoscopic projection system that overcomes previous issues associated with the film projection of such motion pictures. A system that is less costly and delivers a high quality image and experience could be highly beneficial.

It would therefore be useful to provide a design that overcomes the drawbacks associated with previous stereoscopic projection systems.

### BRIEF DESCRIPTION OF THE DRAWINGS

The present invention is illustrated by way of example, and not by way of limitation, in the figures of the accompanying drawings in which:

FIG. 1 is a drawing of the previously known above-and-below stereoscopic format;

FIG. 2 is a drawing of a previously known stereoscopic projection lens suitable for projecting the above-and-below format referenced in FIG. 1;

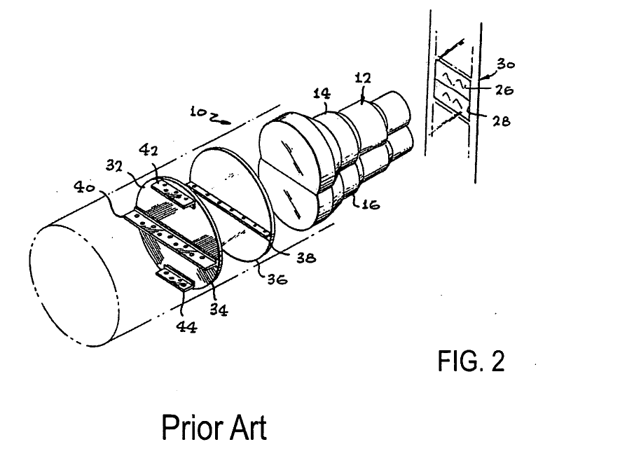

FIG. 3 is the layout of the sideframe head-to-tail, or similar rotation stereoscopic 35 mm film format;

FIG. 4 is a flow chart illustrating the components or stages of the optical or lens system required for stereoscopic projection of the format shown in FIG. 3;

FIG. 5 is one embodiment of the stereoscopic projection system described generally in FIG. 4;

FIG. 6 is another embodiment of the stereoscopic projection system described generally in FIG. 4;

FIG. 7 is the layout of the sideframe head-to-head or opposite-sense rotation stereoscopic 35 mm film format;

FIG. 8 is a flow chart illustrating the components or stages of the optical or lens system required for stereoscopic projection of the format shown in FIG. 7;

FIG. 9 is the embodiment of the stereoscopic projection system described generally in FIG. 8;

FIG. 10 is the layout of the sideframe similar-sense rotation stereoscopic 35 mm film format;

FIG. 11 is a flow chart illustrating the components or stages of the optical or lens system required for stereoscopic projection of the format shown in FIG. 10; and

FIG. 12 is the embodiment of the stereoscopic projection system described generally in FIG. 11.

### DETAILED DESCRIPTION OF THE INVENTION

The present design is a projection arrangement that employs linear polarization, using materials that are far less costly than circular polarization, the form of polarization image selection presently used for most stereoscopic digital projection. Multiple embodiments of the present design are provided, with each embodiment offering advantages over previous designs.

Current stereoscopic projectors use circular polarization based on the ZScreen (Lipton, U.S. Pat. No. 4,792,850) in conjunction with a DMD digital projector. The ZScreen electro-optical device intrinsically outputs circularly polarized light.

Linear polarization provides a much higher dynamic range than circular polarization (an order of magnitude) and thus does not require removal of artifacts known as “ghost images” or “ghosts.” The dynamic range of system polarization is directly related to channel isolation; it is one of the hallmarks of a good quality stereoscopic image for the left and right images to be well isolated with little or no crosstalk or leakage of one perspective image into the other. The ghost image reduction cannot work well with high contrast or dark background images, adds to the costs of print manufacturing, and also may require the studios to distribute more than one kind of print for the release of a feature film.

If desired, it is possible to use circular polarizing filters in the present design, but because of the aforementioned cost and channel isolation advantages, linear polarization is preferred.

The present design is for projecting stereoscopic motion pictures using a single 35 mm motion picture projector, and a 35 mm motion picture film print using an advantageous stereo pair format, and a new type of projection optic. The dominant prior art stereoscopic 35 mm motion picture projection system—the above-and-below format (as referenced above)—had serious defects, including the tendency of the image to be spliced at the subframe frameline thus producing a pseudostereoscopic rather than a stereoscopic image. That and other defects of previous designs are addressed by the present design.

In addition, the present design is far less costly to implement in theaters than digital projectors, which are now the dominant technique for projecting stereoscopic movies. It is far less expensive because a digital projector does not need to be purchased, and because, unlike the dominant method for polarization image selection—namely circular polarization—this new process uses linear polarization with correspondingly less expensive eyewear. By reducing the cost of installation and the ongoing operating costs, the medium becomes more affordable. Compared with digital projection, there is no loss of image quality and, indeed, certain artifacts associated with the projection of digital stereoscopic images—namely judder and spurious temporal parallax produced by the inability to simultaneously project both images—are entirely eliminated.

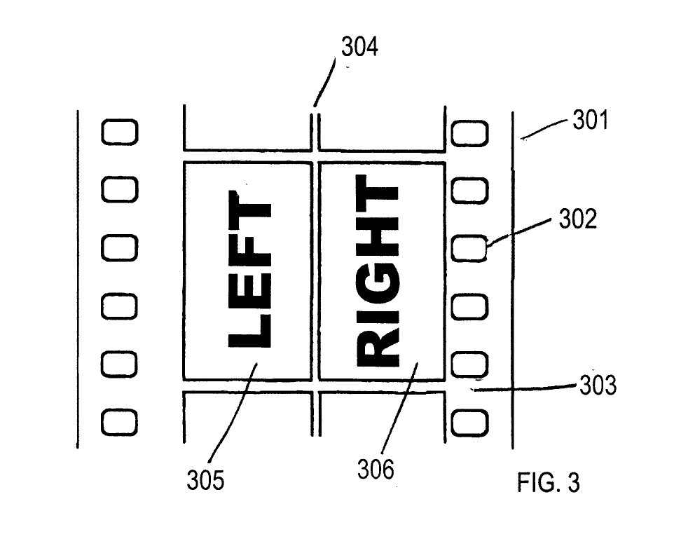

A technology comprised of a 35 mm film format and a lens system for projecting stereoscopic motion pictures using a conventional 35 mm motion picture projector is disclosed. In this embodiment, the system's film format is shown in FIG. 3, comprising a 35 mm motion picture film print 301, said print having sprocket holes typically at points 302. Two sideframes, 305 and 306, are a stereo pair—one a left image, and the other a right image.

It is immaterial which image is left and which image is right, and as one familiar with the art will understand, as long as a standard disposition is maintained so that a stereoscopic rather than a pseudostereoscopic image will always be projected. Similarly, a worker skilled in the art will readily recognize that there is no loss of generality with regard to that which is disclosed herein if both sideframe images are similarly rotated through 180 degrees as depicted as long as a standard is maintained in the production and projection of the motion picture. In other words, with regard to the sideframe images depicted in FIG. 3, a clockwise rotation results in a proper image orientation, but just so long as a standard is maintained, as noted previously, a counterclockwise rotation of images rotated 180 degrees with respect to those shown in FIG. 3 should and in most cases will produce a good result and is an acceptable variation.

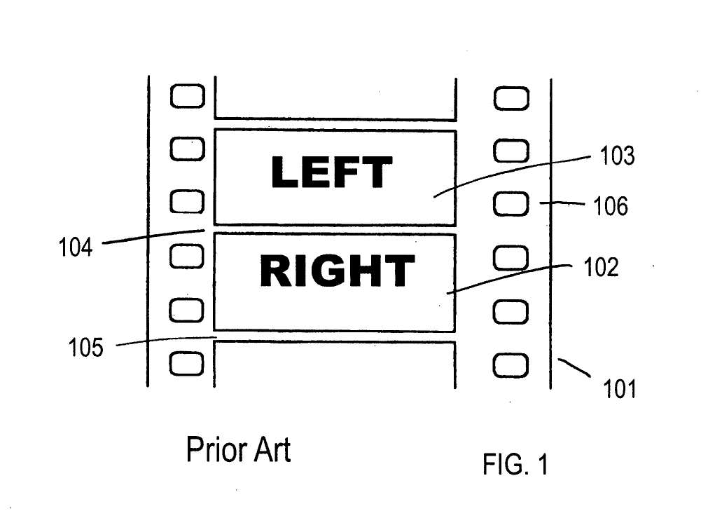

The frameline, which is in the standard frameline position 303, separates sideframe pairs from each other. This frameline serves the same purpose that it serves in the projection of conventional planar movies. The sideframe frameline 304 is illustrated, and is required to separate the sideframes. The format is specifically designed so that when a splice is made at frameline 303, the spatial relationship of left and right images 305 and 306 is preserved and the position of sideframes is not interchanged, as would be the case if a splice was made, with regard to FIG. 1, at line 104 rather than line 105—line 105 being the frameline and line 104 being the subframe frameline. If a splice in the assembly of reels is made in FIG. 1 at line 104, the sequence of images transforms from left-right-left-right to, for example, left-right-right-left-right. The result of this misassembly is that the projected image becomes pseudostereoscopic rather than stereoscopic. This cannot occur in the format depicted in FIG. 3, since a splice at point 303 or all similar framelines unequivocally preserves the spatial relationship between sideframes 305 and 306.

In addition, since sideframes 305 and 306 must be similarly rotated in order to be viewed—in other words, sideframe 305 and sideframe 306 must both be rotated, as shown, clockwise through 90 degrees in order to be viewed as a properly oriented image—the relative unsteadiness of both sideframes is maintained. In prior sideframe systems such as that described by Dewhurst in U.S. Pat. No. 2,693,128, the sideframes, which are head-to-head (or tail-to-tail), need to be rotated in opposite directions. In such a case, the worst possible film registration or steadiness occurs.

“Steadiness” refers to the phenomenon innate to the mechanical transport that requires a motion picture to be indexed one frame at a time, and positioned one frame at a time in the projector gate. This is accomplished by a sprocket-drive in which sprocket wheels transport the film by engaging the perforations such as those shown in 302, and advancing the film the height of one frame. This must produce some degree of vertical unsteadiness (jump or jitter) because successive frames cannot be perfectly indexed in exactly the same location because of factors such as wear and tear on the sprocket holes themselves. As long as the unsteadiness or lack of perfect registration is a small percentage of the screen height, the image is acceptable for viewing. The horizontal unsteadiness is called “weave,” and is caused by the side-to-side motion of the film.

Since, as shown in FIG. 3, both sideframes 305 and 306 must be rotated through 90 degrees, what had been weave or horizontal unsteadiness becomes vertical unsteadiness (and vice versa); since both images are rotated in the same direction the unsteadiness—or, if one prefers, the steadiness—is exactly the same for both images. On the other hand, for prior motion picture images that required a 90-degree opposite rotation of the sideframes (head-to head or tail-to-tail), the unsteadiness was the worst possible unsteadiness since the images were moving in the opposite direction relative to each other.

The effective utilization of the available film area is crucial in a format of this type that uses two sideframes in the area that had heretofore been devoted to a single image. Movies are projected in two aspect ratios: 1.85:1 known as widescreen and 2.35:1 known as scope (or letter box). The prior subframe format illustrated in FIG. 1 produces scope images whereas the sideframe format shown in FIG. 3 produces widescreen images. The advantage is that the instant format provides a better utilization of available film area. A mild anamorphic lens, approximately 1.3:1, may be employed to stretch the 1.85:1 image to fill the scope-size screen. A more likely approach for using the above-and-below format as shown in FIG. 1 to produce a 1.85:1 aspect ratio is by cropping the left and right sides of the stereo pairs, which results in a reduction of almost one quarter of the effective image area. This will in turn result in a substantial reduction in brightness and sharpness. Both 1.85:1 and 2.35:1 aspect ratio movies must be accommodated but the sideframe, rather than the subframe, approach provides a better transition from one aspect ratio to the other in terms of effective utilization of frame or film area.

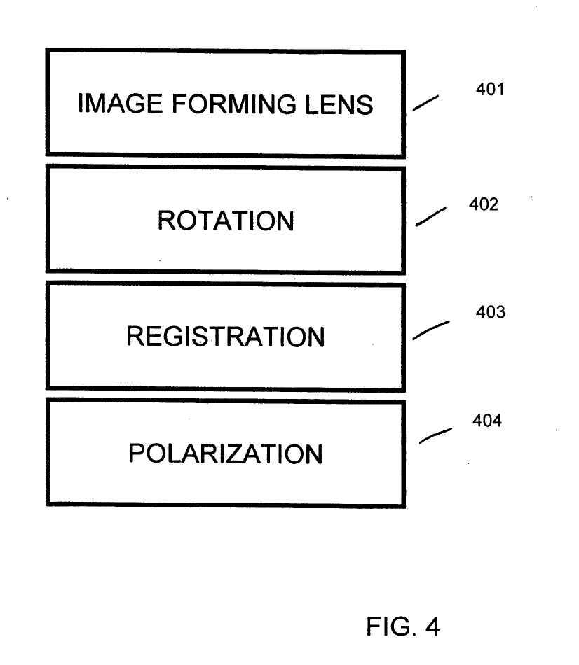

FIG. 4 is a block diagram of the functional optical components or stages necessary for producing a projected stereoscopic image using this embodiment according to the format depicted in FIG. 3. Stage 401 is the image forming lens—a lens that can image the frame that is in the gate and project it onto a motion picture screen. Stage 402 is the rotation stage necessary for properly orienting the images in order to turn them right-side-up. Stage 403 is the registration stage, a term understood to those skilled in the art, but generally represents transforming different sets of data, such as two different images, into a single coordinate system. The terms “superimposition” or “convergence” could be used in place of registration. The images must be vertically registered so that they superimpose on the screen, as is the custom for projecting a stereo pair. That is to say, a horizontal line must be able to be passed though homologous points. Finally, stage 404 shows the polarization stage, which is required for encoding the images with polarization information for image selection.

Linearly polarized light is employed because of its high dynamic range or contrast ratio and because analyzing eyewear are far less expensive than the alternative circular polarization eyewear. Circular polarized light can be used by simply using circular polarizing filters in place of linear ones.

Good quality circular polarizers, or a circular polarizer analyzer and a ZScreen when measured on an optical bench, can have a contrast ratio of about 500:1. Contrast ratio (sometimes called dynamic range) is a measure of the polarizer's extinction efficiency. To clarify by way of example: The transmission of light is measured for two linear polarizers with axes parallel. Next, the transmission of light is measured for the two linear polarizers with axes crossed. The ratio of those two numbers is the contrast ratio and provides a measure of how much light leaks through the crossed axes polarizers. For circular polarizers, the ratio of transmission of same handed with opposite handed polarizers is used.

A contrast ratio of 500:1 means that 1/500 of the light (unwanted light) passes through the combination of circular polarizers of opposite handedness. Crossed linear polarizers can be an order of magnitude better in contrast ratio, or about 5,000:1. When total theater system contrast ratio is measured, with a polarization conserving (“silver”) screen as part of the optical system, the result is far different. Light that is polarized is projected onto the screen and the reflected light is measured after having passed through analyzers. For the circular polarization method the contrast ratio is on the order of about 20:1. For linear polarization, the contrast ratio is about 200:1. These numbers relate directly to the audience experience. Circular polarization requires the ghost-reduction technique alluded to above, whereas linear does not because it intrinsically has less leakage.

It is possible to interchange stages 401, 402, 403, and 404. It can be possible to effectively move one optical stage to another location in the flow chart and to interchange it for another. For example, the polarization stage might be placed between rotation and registration. There are design reasons for choosing a particular order in which to perform these required functions, and in some cases, as shall be shown, the functions of individual stages can be combined.

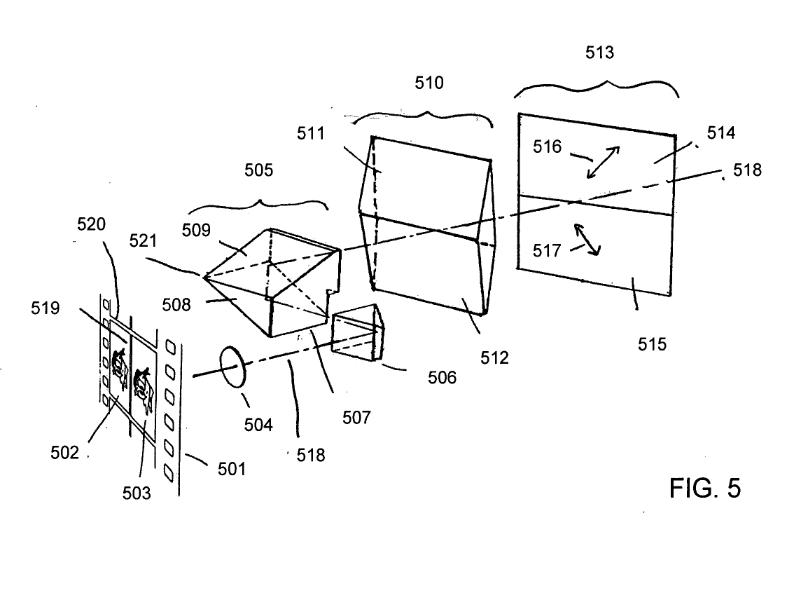

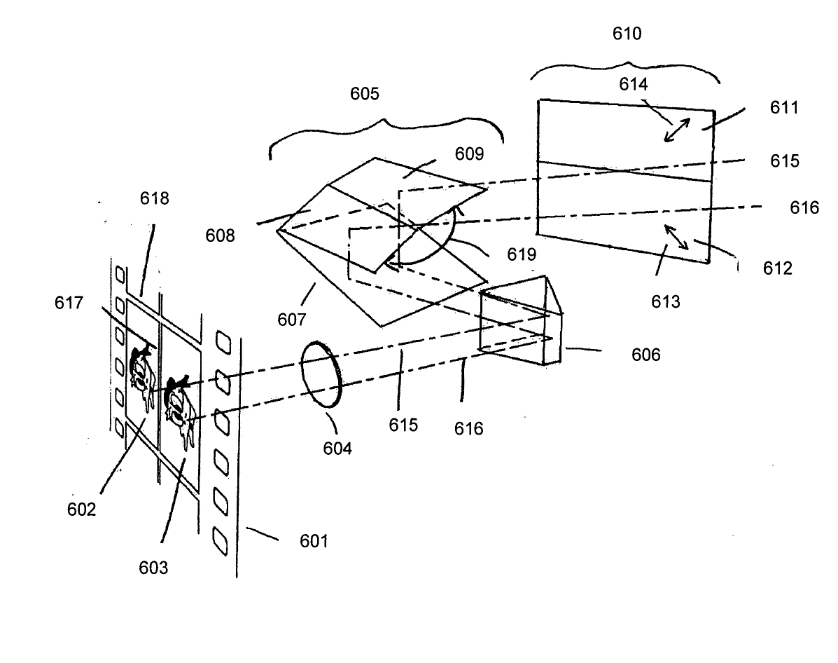

The general formulation for the imaging system provided with the help of FIG. 4 will now be applied to two specific designs. The first design will be described with the aid of FIG. 5. Film 501 is 35 mm motion picture film in a projector (not shown), provided in the orientation of FIG. 3. A different graphic is provided in FIGS. 5 and 6, but the functionality and layout of the film is the same as shown in FIG. 3. The image is being projected onto a screen with polarization-conserving properties (not shown). Also not shown is an audience member wearing polarizing analyzing glasses. The embodiment shown in FIG. 6 leaves out these components as well.

The 35 mm motion picture film is shown as having two sideframes 502 and 503, said sideframes corresponding to the sideframes given in FIG. 3 as sideframes 305 and 306. In addition the conventional frameline 520 and the sideframe frameline 519 are shown. The dotted line 518 is a central light ray that corresponds to both images formed from sideframes 502 and 503 by image-forming lens 504. The light rays then enter the rotation stage 505.

The rotation segment is made up of prism 506, in which the rays 518 are reflected to the prism shown at point 521. All reflecting surfaces are planes in this embodiment. Prism 521 has two reflecting surfaces 508 and 509. It requires three reflecting surfaces in order to rotate the images through 90 degrees, and both sideframe images 502 and 503 are rotated in one rotational step in section 505. In this drawing, and in FIG. 6, the prisms in the rotation section are used for the purpose of reflection. Said reflection can be accomplished by means of a coated reflecting surface or by means of total internal reflection. In addition, all reflecting surfaces shown in FIGS. 5 and 6 may also be front coated mirrors. The result of the rotation segment is sideframes oriented in desired directions.

The rays, as noted, shown by dotted line 518, then traverse the registration stage 510, which is made up of two prisms 511 and 512, are meant to indicate the refraction rather than the reflection of light. These prisms perform their function well if they are of the achromatic type, in order to prevent any color fringing caused by dispersion. The two sections of the prism, sections 511 and 512, cause the rays from sideframes 502 and 503, to eventually register on the coordinate system defined by the screen. Top prism 511 refracts the image of sideframe 502 and bottom prism 512 refracts the image of sideframe 503.

The polarization section 513 is in intimate juxtaposition with to the rotation stage. Polarization section 513 might be placed between sections 505 and 510. In this embodiment, two sheet polarizers make up polarization section 513. These are linear polarizers in one embodiment. However, these may be replaced by circular polarizers of opposite handedness, in which case the argument and discussion would be substantially the same except that one would be dealing with left- and right-handed circular polarizers in contradistinction to linear polarizer 514 with axis 516 and linear polarizer 515 with axis 517. Axes 516 and 517 are orthogonal, as is traditional in this form of image selection, and by convention, each axis is at 45 and 135 degrees respectively to the horizontal. The same arrangement is used in the polarizing section in FIG. 6. Thus, when the rays traverse the image-forming lens, the rotation section, the registration section, and the polarization section—said rays being exemplified by central ray 518—the rays are ready for viewing once reflected from the surface of the screen. Each eye sees its appropriate image when viewed through standard linear polarizing eyewear.

FIG. 6 illustrates a second embodiment. Rather than using separate rotation and registration stages, it combines these stages by means that are described herein. 35 mm film 516 is shown with sideframes 602 and 603, sideframe frameline 617, and standard frameline 618. Central light rays 615 and 616 correspond, respectively, to sideframes 602 and 603. The light passes through image-forming lens 604, after which it traverses rotation/registration stage 605. Prism 606, which incorporates the first reflecting surface, reflects rays from both sideframes 602 and 603. As is true for FIG. 5, all reflecting surfaces are planes. The rotation/registration process continues using additional reflecting surfaces. The second reflecting surface 607 reflects rays from both sideframes 602 and 603. Next are two reflecting surfaces 608 and 609. Reflecting surfaces 608 and 609 are planes that have dihedral angle 619. Reflecting surface 608 reflects rays only from sideframe 603, while reflecting surface 609 reflects rays only from sideframe 602. Dihedral angle 619 can be adjusted by rotating mirror 608 or 609 with respect to each other, and said rotation will then cause the images to come into registration, (convergence, or superimposition) on the plane of the screen (not shown).

The rays, exemplified by central rays 615 and 616, traverse the polarization section 610 and pass through polarizer 611 having axis 614 and polarizer 612 having axis 613. Said axes 614 and 613 are the axes of linear polarizers, and they are orthogonal, as is traditional in this kind of image selection with axes at, respectively, 45 and 135 degrees to the horizontal. As noted earlier with regard to FIG. 5, circular polarizing filters may be employed, in which case the argument would be essentially identical but one would be talking about left- and right-handed circular polarizers in the place of linear polarizers.

Thus it is possible to take the sideframes of this nonstandard format, form an image with them, use a single rotation/registration section to both rotate and cause the images of the sideframes to register and to pass the images through the polarizing filters and to eventually register the respective images on the plane of the screen to be subsequently viewed through polarizing analyzers.

All of the digital or electronic infrastructure for producing stereoscopic motion picture films can be used to produce what is called a “film-out,” of the required sideframe format. In other words, the format as shown in FIG. 3, is completely compatible with computer-generated images, images that are captured by electronic stereoscopic camera rigs or the like, and images that go through the digital intermediate or electronic post production process. By providing the re-sizing and rotation prescription for format arrangement and rotation for the film-out, using standard post production tools, the result will resemble FIG. 3. This film-out is an alternative to the distribution of a digital file for digital projectors and is completely compatible with the existing motion picture manufacturing and 35 mm projection infrastructure. The film-out is in all likelihood in the form of a negative master for the production of positive prints for release.

A general methodology for properly imaging sideframes has been disclosed with the aid of FIG. 4, and more specifically with the aid of FIGS. 5 and 6. The sideframes have significant advantages over the prior art subframes. The sideframes have a more effective and efficient utilization of image area, especially with regard to movies in the 1.85:1 aspect ratio. The image can readily be stretched with a simple low-power anamorphic component with a 1.3:1 expansion ratio, which is far less demanding to design and build than that required for the usual 2:1 used for anamorphics. The efficient utilization produces an image that will be brighter and sharper. In addition, because the sideframes are rotated similarly, they will have identical registration and will be relatively quite steady.

What has been described herein is a stereoscopic projection system that uses 35 mm film to effectively project an excellent-quality 35 mm stereoscopic image. Unlike the prior subframe arrangement used in the 1980's, it is impossible to improperly assemble projection reels or to make a frameline adjustment error to produce a pseudostereoscopic rather than a stereoscopic image. Said format and projection method can take advantage of all the digital electronic production and post production means, and provides a relatively inexpensive alternative to the present digital projection methods in terms of installation and ongoing costs.

The present design thus includes a system for projecting stereoscopic images. The system comprises a light source configured to provide light energy to a length of film having frames each comprising two sideframes identically oriented 90 degrees from a preferred viewing orientation, an image receiving lens configured to receive light energy transmitted through the length of film, and an optical arrangement configured to receive images as light energy from the image receiving lens. The optical arrangement comprises means for reorienting images to the preferred viewing orientation and registering images reoriented to the preferred viewing orientation to a screen. The means for reorienting and registering comprise a plurality of optical refractive elements. The optical arrangement may further include means for polarizing images, such as linearly polarizing images.

The present design also is a method for projecting stereoscopic images. The method includes providing light energy through a length of film having frames each comprising two sideframes identically oriented 90 degrees from a preferred viewing orientation, receiving light energy transmitted through the length of film at an image receiving lens and transmitting images from the image receiving lens, reorienting images to the preferred viewing orientation, and registering images reoriented to the preferred viewing orientation to a screen using a plurality of optical refractive elements. Polarizing images may also occur, such as linearly polarizing images, after reorienting and registering.

The present design also includes a length of stereoscopic film comprising a plurality of frames, each frame in the length of stereoscopic film comprising a first sideframe comprising a first image, the first image having a preferred viewing orientation, wherein the first image is rotated a predetermined angular amount from the preferred viewing orientation and disposed substantially on the left half of one frame, a second sideframe comprising a second image, the second image also having the preferred viewing orientation, wherein the second image is rotated the predetermined angular amount from the preferred viewing orientation and disposed substantially on the right half of the one frame, and a vertically oriented line separating the first sideframe from the second sideframe. The predetermined angular amount may be, for example, plus ninety degrees in one embodiment and minus 90 degrees in another embodiment, but in all cases each sideframe image in a frame has similar orientation.

### Alternate Implementation—Head to Head

The foregoing embodiment provides advantages over previous designs. However, in situations where vignetting is an issue, improvements to such designs can provide highly beneficial results.

Vignetting in general is the reduction in image brightness at the edge or periphery of the motion picture as compared to the image center, and is also known as “hotspotting.” Vignetting can occur as a result of projector settings, filter or lens issues, or other imperfections in the projection technique and apparatus employed.

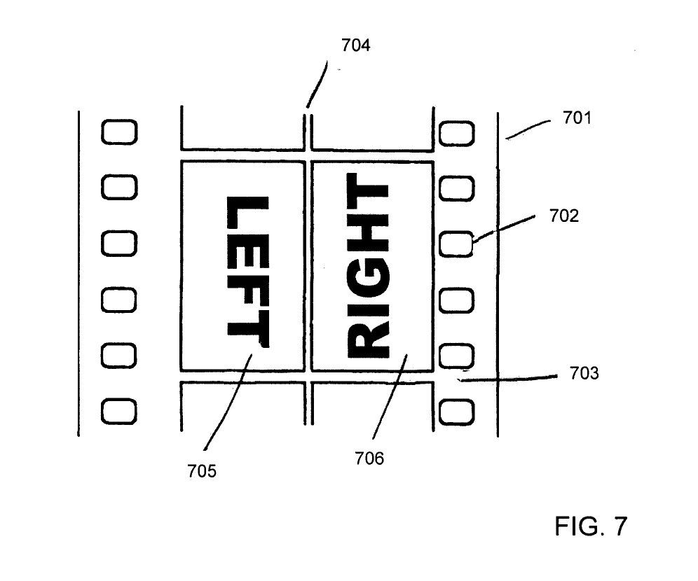

A further embodiment providing a 35 mm film format and an alternate lens system for projecting stereoscopic motion pictures using a conventional 35 mm motion picture projector is disclosed. The present format is shown in FIG. 7, depicting a 35 mm motion picture film print 701, said print having sprocket holes typically at points 702. Two sideframes 705 and 306 are a stereo pair—one a left image, and the other a right image. Again, it is immaterial which image is left and which image is right, and as one familiar with the art will understand, as long as a standard disposition is maintained so that a stereoscopic rather than a pseudostereoscopic image is always projected.

The sideframes 705 and 706 are labeled left and right, respectively, and their orientations are indicated by the orientation of the lettering used to identify them. That is to say, the sideframes are oriented so that left and right images are head-to-head. To be properly superimposed upon projection the left image must be rotated counterclockwise and the right image clockwise.

The frameline, which is in the standard frameline position 703, separates sideframe pairs from each other and serves the same purpose that it did for the projection of conventional planar movies. The sideframe frameline 704 is required to separate the sideframes. The format is specifically designed so that when a splice is made at frameline 703, the spatial relationship of left and right images 705 and 706 is preserved and the position of sideframes is not interchanged, as would be the case if a splice was made, with regard to FIG. 1, at line 104 rather than line 105. The result of this misassembly is that the projected image becomes pseudostereoscopic rather than stereoscopic. This cannot occur in the format depicted in FIG. 7, since a splice at point 703 or all similar framelines will unequivocally preserve the spatial relationship between sideframes 705 and 706.

This head-to-head orientation promotes having left and right images with symmetrical illumination characteristics since any lens vignetting appears in the same relatively position for superimposed left and right projected images.

The effective utilization of the available film area is crucial in a format of this type that uses two sideframes in the area that had been devoted to a single image. The advantage of the implementation of FIG. 7 is that the format provides a better utilization of available film area for the projection of 1.85:1 aspect ratio movies.

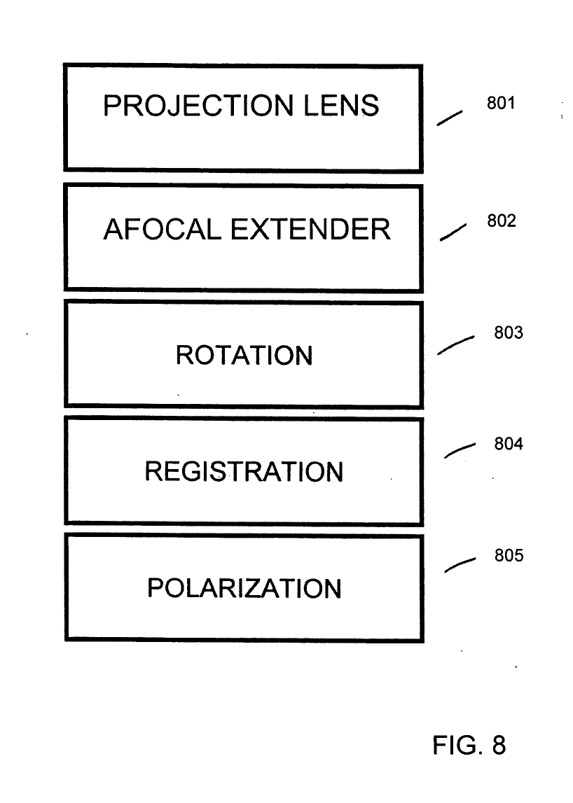

FIG. 8 is a block diagram of the functional optical components or stages necessary for producing a projected stereoscopic image, using the format depicted in FIG. 7. Stage 801 is the image forming projection lens. Stage 802 is the afocal extender. The reasons for using the afocal extender are two-fold: sideframes, when rotated orthogonally using the projection lens that is in place and without any screen cropping, will not quite fill the screen. Therefore it is preferable to decrease the focal length of the projection lens by approximately 16% to increase the effective magnification of the image.

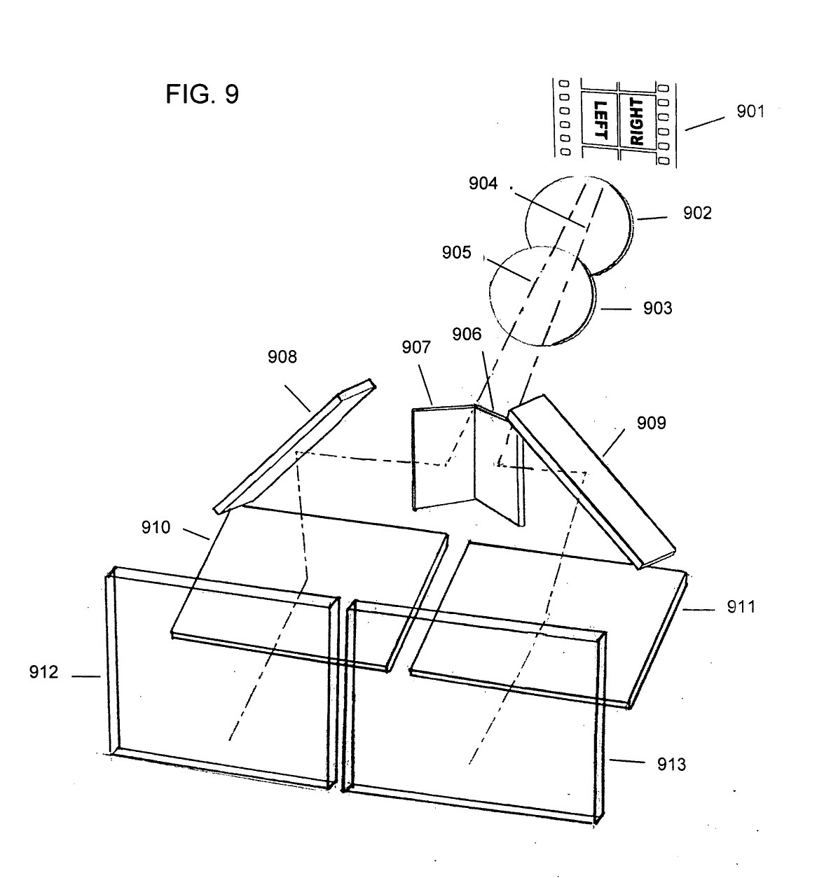

Second, it is preferable for the rotational optics, as shown in FIG. 9, to be in close proximity with the front element or exit pupil of the refractive stages, namely stages 801 and 802. This keeps the size of the rotational stage to a minimum for reasons of cost of goods and convenience; a bulk unit is harder to install and handle. Moreover, many projection lenses, because of the way they are mounted on the projector, do not readily allow for mounting of the rotational component in intimate juxtaposition. Accordingly, the afocal extender not only shortens the focal length of the lens but also extends the exit pupil to conform to the requirements of the rotational stage. The design of afocal convertors is known to those practicing the art.

Rotation stage 803 facilitates proper orientation of the images in order to turn them right-side-up. Stage 804 is the registration stage. The terms “superimposition” or “convergence” may be used in place of registration. The images are preferably vertically registered so that they superimpose on the screen, as is the custom for projecting a stereo pair. That is to say, a horizontal line passes though homologous points. In addition, their horizontal alignment is of great importance so that the so-called stereo window location is maintained.

Finally, stage 805 is the polarization stage, which encodes the images with polarization information for image selection. As noted, linearly polarized light is preferentially employed because of its high dynamic range, or contrast ratio, and because the eyewear are far less expensive than the alternative circular polarization eyewear. Circular polarized light may be used by simply using circular polarizing filters in place of linear ones.

Contrast ratio, or dynamic range, considerations remain as discussed above. It has been empirically verified that a dynamic range on the order of 20:1 does not provide a good quality stereoscopic image, whereas a dynamic range on the order of 200:1 does provide a good visual experience. Thus the present design preferably employs linear polarization for image selection.

It may be possible to effectively change the order of some of the optical stages to other locations in the flow chart FIG. 8. For example, the polarization stage might be placed between rotation and registration. There are design reasons for choosing a particular order in which to perform these required functions, and in some cases, as shall be shown, the functions of individual stages can be combined.

The general formulation for the imaging system and its required functional components or stages as provided with the help of FIG. 8 will now be applied to the embodiment illustrated in FIG. 9.

FIG. 9 is a diagrammatic illustration of the optical system of the present design. FIG. 9 is a perspective view designed for didactic purposes. Film with the sideframe format, as given in FIG. 7, is shown as film 901. The projection lens 902 corresponds to element 801 of FIG. 8, and the afocal extender 903 corresponds to element 802. Axial light rays 905 and 904 from the left and right sideframes are shown. Lens 902 may, in practice, flip the image of the sideframes upside down and left to right, but for simplicity this is not shown and rather the rays are shown emerging directly from the sideframes.

The optical path for the left subframe is given by axial ray 905 which is reflected by mirrors 907, 908, and 910, passing through selection filter 912. The optical path for the right subframe is given by axial ray 904 and mirrors 906, 909, 911 passing through selection filter 913.

The rays are illustrated with two kinds of lines, long dashes mixed with short dashes, and simply short dashes. The short dashes indicate that the rays are being seen through the mirrors, in particular, the “V” shaped mirror ensemble 906, 907, whose mirror surfaces are facing away from the reader and towards the refractive components and the film. All of the mirrors have planar surfaces and typically are front surface mirrors or Dichroic mirrors. The planes of mirrors 906 and 907 are typically orthogonal to each other.

The axial or central light ray 905, meant to represent the left image, is reflected by inward facing mirror surface 907 and on to the mirror 908, thence to mirror 910, and finally through polarizer 912. The cited mirror surfaces rotate the image counterclockwise orthogonally and then direct the image through the polarizer 912 and onto the projection screen (not shown).

Similarly, the axial or central light ray 904, meant to represent the right image, is reflected by inward facing mirror surface 906 and on to the mirror 909, to mirror 911, and finally through polarizer 913. This will result in clockwise orthogonal rotation. The image is then directed through the polarizer 913 and onto the projection screen (not shown).

As noted, mirror combination 906 and 909 create the orthogonal rotation of the right image, as is the case for mirror combination 907 and 908. The left and right sideframes can have their perspective views interchanged without loss of generality as long as the selection filters 912 and 913 are properly adjusted.

Mirrors 910 and 911, respectively, allow for the superimposition function and provide for, by well known mechanical rotational means, rotation about the X and Y axes, the ability to shift light rays represented by axial rays 904 and 905. Said rays may be shifted separately, in the vertical and/or horizontal direction, to deflect the rays so that they can allow the left and right images to be properly superimposed on the projection screen.

The mirrors 906 and 907 are respectively positioned at 45 degrees to rays 904 and 905, and, as noted, at 90 degrees to each other. Thus, the left and right images are directed in opposite directions, toward mirrors 909 and 908. Mirrors 906 and 907 serve two purposes: They divide the combined sideframe image that originates from the film, and they redirect these images to the mirrors 909 and 908. Mirrors 909 and 908 are at 45 degrees to the respective axial rays 905 and 904 after they have been reflected by mirrors 907 and 906, respectively, and are oriented such that the images are now aimed downward toward mirrors 911 and 910. Mirrors 910 and 911 redirect the left and right images, respectively, toward the screen. The rays 905 and 904 then pass through two image selection filters, 912 and 913, respectively.

These selection filters serve the purpose of encoding each image separately such that they may be decoded by the viewing eyewear worn by members of the audience. In this way the filters serve to preserving the perspective information inherent in the sideframes. As such, they may be of various types, such as linear polarizing, circular polarizing, or bicolor anaglyph, for example.

In the present design linear polarizers are generally preferred. As is well known by practitioners of the art, the axes of the linear polarizers must be orthogonal and the analyzers of the eyewear selection devices, not shown, must have corresponding and complimentary orientations. Similar remarks can be made with regard to the use of circular polarizers for image selection. Left and right handed circular polarizers are preferably employed for filters 912 and 913 with corresponding circular polarization filters employed as analyzers in eyewear.

The end result is that the left and right images will be properly oriented and superimposed on the projection screen and appropriately polarized for projection onto a polarization conserving screen with image selection to take place when viewed through appropriate eyewear.

What has been described herein is a stereoscopic projection system that uses 35 mm film to effectively project an excellent-quality 35 mm stereoscopic image. Unlike the prior subframe arrangement used in the 1980's, it is impossible to improperly assemble projection reels or to make a frameline adjustment error to produce a pseudostereoscopic rather than a stereoscopic image. Said format and projection method can take advantage of all the digital electronic production and post production means, and provides a relatively inexpensive alternative to the present digital projection methods in terms of installation and ongoing costs.

The present embodiment thus includes a system for projecting stereoscopic images. The system comprises a light source configured to provide light energy to a length of film having frames each comprising two sideframes respectively oriented 90 degrees from a preferred viewing orientation, said sideframes oriented head-to-head, the left sideframe requiring counterclockwise rotation and the right sideframe requiring clockwise rotation, an image receiving lens configured to receive light energy transmitted through the length of film, and an optical arrangement configured to receive images as light energy from the image receiving lens. An afocal extender both reduces the focal length of the projection lens and moves the refractive optical component's exit pupil toward the rotational component.

The optical arrangement comprises means for reorienting images to the preferred viewing orientation and registering images reoriented to the preferred viewing orientation to a screen. The means for reorienting and registering comprise a plurality of optical refractive elements. The optical arrangement may further include means for polarizing images.

The present embodiment also includes a method for projecting stereoscopic images. The method includes providing light energy through a length of film having frames each comprising two sideframes oriented 90 degrees but oppositely from each other in a head-to-head configuration from a preferred viewing orientation, receiving light energy transmitted through the length of film at an image receiving lens and transmitting images from the image receiving lens, reorienting images to the preferred viewing orientation, and registering images reoriented to the preferred viewing orientation to a screen using a plurality of optical refractive elements. Polarizing images may also occur, such as after reorienting and registering.

The present embodiment also includes a length of stereoscopic film comprising a plurality of frames, each frame in the length of stereoscopic film comprising a first sideframe comprising a first image, the first image having a preferred viewing orientation, wherein the first image is rotated a predetermined angular amount from the preferred viewing orientation and disposed substantially on the left half of one frame, a second sideframe comprising a second image, the second image also having the preferred viewing orientation, wherein the second image is rotated 180 degrees from the preferred viewing orientation and disposed substantially on the right half of the one frame, and a vertically oriented line separating the first sideframe from the second sideframe. The predetermined angular amount may be, for example, plus ninety degrees on the left and minus ninety degrees on the right (head to head) in one embodiment and minus ninety degrees on the left and plus ninety degrees on the right (tail to tail) in another embodiment.

### Alternate Implementation—Enhanced Head-to-Tail

While the foregoing “head-to-head” design provides certain advantages over previously known systems, in certain instances the artifacts resulting from slight movements in the film during indexing or other projection operation. Such slight movements, when the head-to-head arrangement is employed, can result in judder that is opposite in direction, which can create an unacceptable image. Thus a design that removes this artifact can be advantageous.

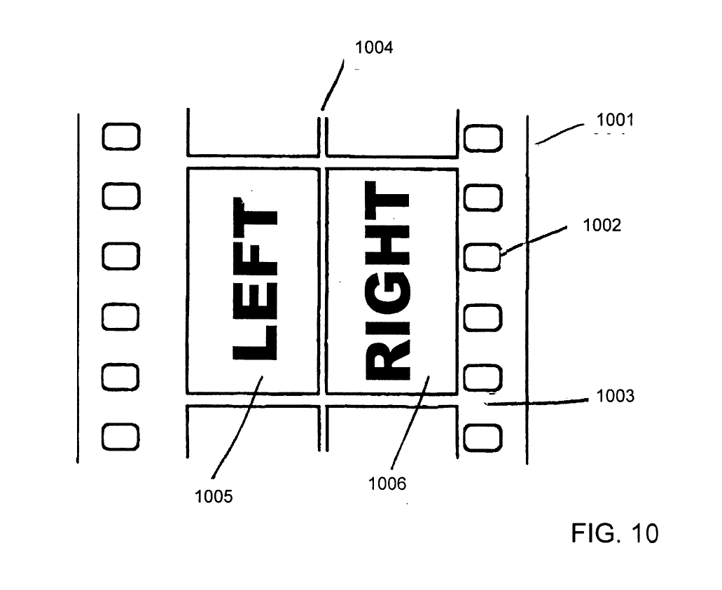

A further embodiment comprised of a 35 mm film format and a lens system for projecting stereoscopic motion pictures using a conventional 35 mm motion picture projector is disclosed. The system's format is shown in FIG. 10, depicting a 35 mm motion picture film print 1001, said print having sprocket holes typically at points 1002. Two sideframes 1005 and 1006 are a stereo pair—one a left image, and the other a right image. Again, it is immaterial which image is left and which image is right, and as long as a standard disposition is maintained, a stereoscopic rather than a pseudostereoscopic image will always be projected.

The sideframes 1005 and 1006 are labeled left and right, respectively, and their orientations are indicated by the orientation of the lettering used to identify them. That is to say, the sideframes are oriented so that left and right images have a similar-sense of rotation. To be properly superimposed upon projection the left and right images must, for the case illustrated in FIG. 10, both be rotated clockwise. The invention could also be disclosed with sideframes both rotated through 180 degrees from that which is illustrated here so that counter-clockwise rotation would be required with no loss of generality, as one skilled in the art will understand.

The frameline, which is in the standard frameline position 1003, separates sideframe pairs from each other and serves the same purpose that it did for the projection of conventional planar movies. The sideframe frameline 1004 is illustrated, and is required to separate the sideframes. The format is specifically designed so that when a splice is made at frameline 1003, the spatial relationship of left and right images 1005 and 1006 is preserved and the position of sideframes is not interchanged.

This similar-sense orientation promotes having left and right projected images with symmetrical motion characteristics since any intermittent indexing imperfection of the film and motion picture appear in the same relatively position for superimposed left and right projected images. Thus the relative steadiness of the left and right projected images has the same relative steadiness as planar images when projected using the same projection apparatus.

“Steadiness” in this context refers to the phenomenon innate to the mechanical transport that requires a motion picture to be indexed one frame at a time, and positioned one frame at a time in the projector gate. This is accomplished by a sprocket-drive in which sprocket wheels transport the film by engaging the perforations such as those shown as perforations 302, and advancing the film the height of one frame. This can produce some degree of vertical unsteadiness, called “jump”, because successive frames cannot be perfectly indexed in exactly the same location due to factors such as wear and tear on the sprocket holes themselves. As long as the unsteadiness or lack of perfect registration is a small percentage of the screen height, the resultant stereoscopic image is acceptable for viewing. The horizontal unsteadiness is called “weave,” and is caused by the side-to-side motion of the film. “Jump” has a 24 frames per second frequency and “weave” typically has a slower frequency.

Since, as shown in FIG. 3, both sideframes 305 and 306 are rotated through 90 degrees, what had been weave or horizontal unsteadiness becomes vertical unsteadiness (and vice versa); since both images are rotated in the same direction the unsteadiness—or, if one prefers, the steadiness—is exactly the same for both images.

Again, an additional advantage of the format employed in FIG. 10 is that the format provides a better utilization of available film area for the projection of 1.85:1 aspect ratio movies.

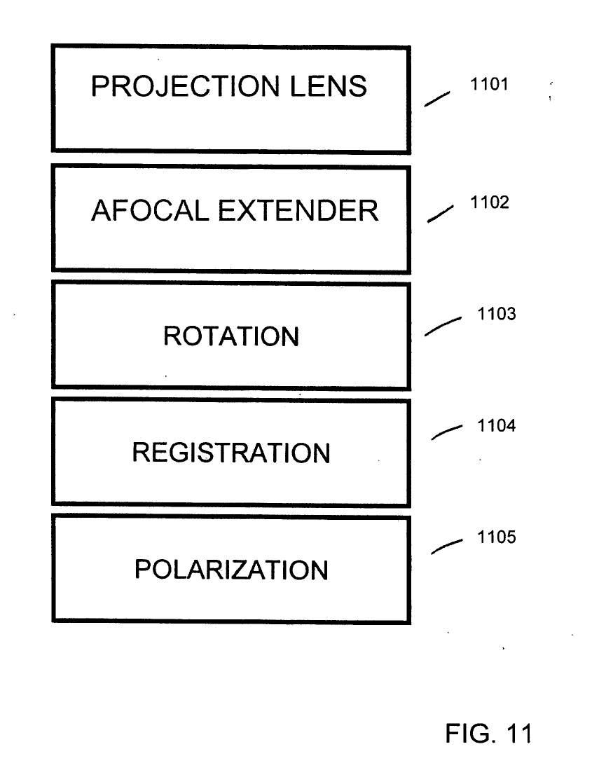

FIG. 11 is a block diagram of the functional optical components or stages necessary for producing a projected stereoscopic image, using the format depicted in FIG. 10. Stage 1101 is the image forming projection lens. Stage 1102 is the afocal extender. The reasons for using the afocal extender are two-fold: sideframes, when rotated orthogonally using the projection lens that is in place and without any screen cropping, will not quite fill the screen. Therefore it can be preferable to decrease the focal length of the projection lens by a value such as a percentage, such as approximately 16%, to increase the effective magnification of the image.

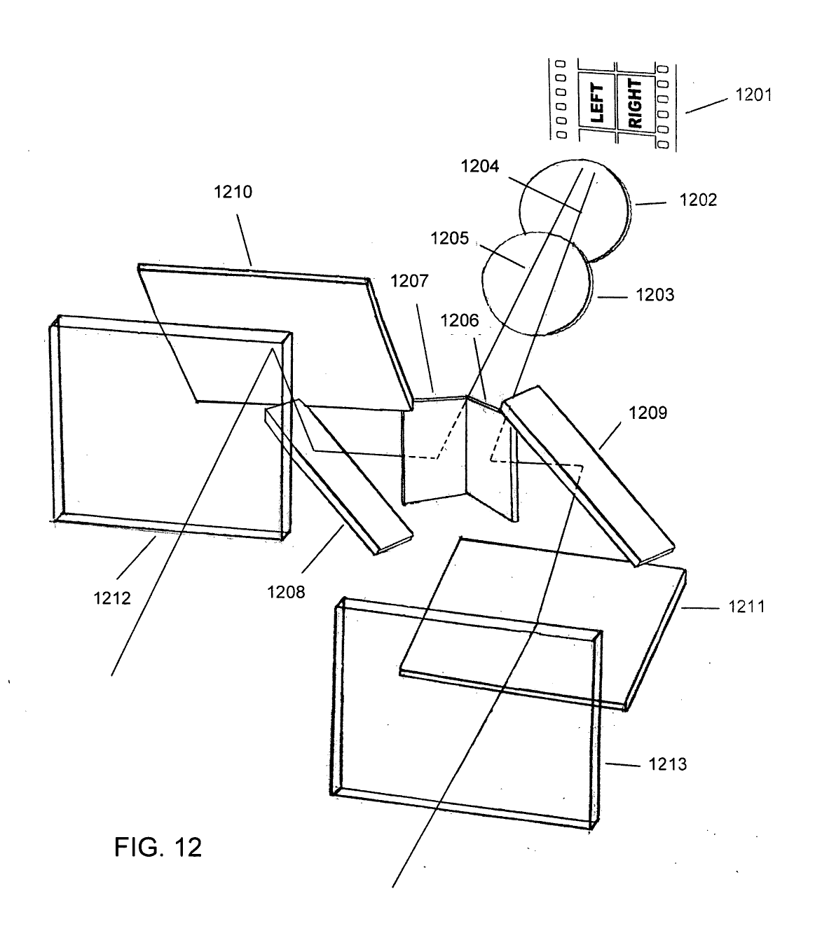

Second, it can be beneficial for the rotational optics, as shown in FIG. 12, to be in close proximity with the front element or exit pupil of the refractive stages, namely stages 1101 and 1102. This keeps the size of the rotational stage to a minimum for reasons of cost of goods and convenience; a bulky unit is harder to install and handle. Moreover, many projection lenses, because of the way they are mounted on the projector, do not readily allow for mounting of the rotational component in intimate juxtaposition. Accordingly, the afocal extender 1102 not only shortens the focal length of the lens but also extends the exit pupil to conform to the requirements of the rotational stage. The design of afocal convertors is well known to those practicing the art and devices of this type have been manufactured for about a century so such a device will not be discussed in detail here.

Rotation stage 1103 facilitates proper orientation of the images in order to turn them right-side-up. Stage 1104 is the registration stage, and the terms “superimposition” or “convergence” may be used in place of registration. The images are vertically registered so that they superimpose on the screen, as is the custom for projecting a stereo pair. That is to say, a horizontal line passes though homologous points. In addition, their horizontal alignment is of great importance so that the so-called stereo window location is maintained.

Finally, stage 1105 is the polarization stage, required for encoding the images with polarization information for image selection. As noted, linearly polarized light is employed because of its high dynamic range, or contrast ratio, and because the eyewear are far less expensive than the alternative circular polarization eyewear. Circular polarized light may be used by simply using circular polarizing filters in place of linear ones.

Good quality circular polarizers, or a circular polarizer analyzer and a ZScreen when measured on an optical bench, can have a contrast ratio of about 500:1. As discussed above, a contrast ratio of 500:1 means that 1/500 of the light (unwanted light) passes through the combination of circular polarizers of opposite handedness. Crossed linear polarizers can be an order of magnitude better in contrast ratio, or about 5,000:1. When total theater system contrast ratio is measured, with the polarization conserving “silver screen” as part of the optical system, the result is far different. Light that is polarized is projected onto the screen and the reflected light is measured after having passed through analyzers.

For the circular method the contrast ratio is on the order of about 20:1. For linear polarization, the contrast ratio is about 200:1. These are meaningful numbers because they relate directly to the audience experience. It has been empirically verified that a dynamic range on the order of 20:1 does not provide a good quality stereoscopic image, whereas a dynamic range on the order of 200:1 does provide a good visual experience. Thus the present design employs linear polarization for image selection.

It may be possible to effectively change the order of some of the optical stages to other locations in the flow chart FIG. 11. For example, the polarization stage might be placed between rotation and registration. Order in which to perform these required functions can occur based on design preferences and circumstances encountered, and in some cases, as shall be shown, the functions of individual stages can be combined.

The general formulation for the imaging system and its required functional components or stages as provided with the help of FIG. 11 will now be applied to the embodiment illustrated in FIG. 12.

FIG. 12 is a diagrammatic illustration of the optical system of the present design. FIG. 12 is a perspective view of the design. Film with the “sideframe” format, as given in FIG. 10, is shown as film 1201. The projection lens 1202 corresponds to element 1101 of FIG. 11, and the afocal extender 1203 corresponds to element 1102. Axial light rays 1205 and 1204 from the left and right sideframes are shown. Lens 1202 may, in practice, flip the image of the sideframes upside down and left to right, but for simplicity this is not shown and rather the rays are shown emerging directly from the sideframes.

The optical path for the left subframe is given by axial ray 1205 which is reflected by mirrors 1207, 1208, and 1210, passing through selection filter 1212. The optical path for the right subframe is given by axial ray 1204 and mirrors 1206, 1209, 1211 passing through selection filter 1213.

The rays are illustrated with two kinds of lines, solid lines for rays that are not obscured by parts and dashed lines for rays obscured by parts, specifically parts 1206, 1207, and 1209. The dashes indicate that the rays are seen through the mirrors, in particular, the “V” shaped mirror ensemble 1206, 1207, whose mirror surfaces are facing away from the reader and towards the refractive components and the film. All of the mirrors have planar surfaces and typically are front surface mirrors or Dichroic mirrors. The planes of mirrors 1206 and 1207 are typically orthogonal to each other.

The axial or central light ray 1205, representing the left image, is reflected by inward facing mirror surface 1207 and on to the mirror 1208, to mirror 1210, and finally through polarizer 1212. The cited mirror surfaces rotate the image clockwise orthogonally and then direct the image through the polarizer 1212 and onto the projection screen (not shown).

Similarly, the axial or central light ray 1204, representing the right image, is reflected by inward facing mirror surface 1206 and on to the mirror 1209, thence to mirror 1211, and finally through polarizer 1213. This results in clockwise orthogonal rotation. The image is then directed through the polarizer 1213 and onto the projection screen (not shown).

As noted, mirror combination 1206 and 1209 create the orthogonal rotation of the right image, as is the case for mirror combination 1207 and 1208. The left and right sideframes can have their perspective views interchanged without loss of generality as long as the selection filters 1212 and 1213 are properly adjusted.

Mirrors 1210 and 1211, respectively, allow for the superimposition or registration function called out in FIG. 11 as element 1104 and provide for, by well known mechanical rotational means, rotation about the X and Y axes, providing an ability to shift light rays represented by axial rays 1204 and 1205. Said rays may be shifted separately, in the vertical and/or horizontal direction, to deflect the rays so that they can allow the left and right images to be properly registered on the projection screen.

The mirrors 1206 and 1207 are respectively positioned at 45 degrees to rays 1204 and 1205, and, as noted, at 90 degrees to each other. Thus, the left and right images are directed in opposite directions, toward mirrors 1209 and 1208. Mirrors 1206 and 1207 serve two purposes: They divide the combined sideframe image that originates from the film, and they redirect these images to the mirrors 1209 and 1208. Mirrors 1209 and 1208 are at 45 degrees to the respective axial rays 1205 and 1204 after they have been reflected by mirrors 1207 and 1206, respectively, and are oriented such that the images are now aimed downward toward mirrors 1211 and 1210 respectively. Mirrors 1210 and 1211 redirect the left and right images, respectively, toward the screen as noted above. The rays 1205 and 1204 then pass through two image selection filters, 1212 and 1213, respectively.

These selection filters serve the purpose of encoding each image separately such that they may be decoded by the viewing eyewear worn by members of the audience. In this way the filters serve to preserve the perspective information inherent in the sideframes. As such, they may be of various types, such as linear polarizing, circular polarizing, or bicolor anaglyph, for example.

In the present design linear polarizers are generally preferred. The axes of the linear polarizers must be orthogonal and the analyzers of the eyewear selection devices, not shown, have corresponding and complimentary orientations. Similar remarks can be made with regard to the use of circular polarizers for image selection. Left and right handed circular polarizers are preferably employed for filters 1212 and 1213 with corresponding circular polarization filters employed as analyzers in eyewear.

The end result is that the left and right images are properly oriented and superimposed on the projection screen and appropriately polarized for projection onto a polarization conserving screen with image selection to take place when viewed through appropriate eyewear.

By the principle of binocular symmetry of illumination the left and right fields should have similar illumination patterns. By experiment it has been determined that the instant optical arrangement, as depicted in FIGS. 11 and 12, promotes such a desired result. The reason for this is that both left and right sideframe rays, as exemplified by rays 1204 and 1205, see similar illumination patterns because they are offset by only a small distance from the optical center of the projector lamp (not shown). Said patterns are then used for image formation, and the output of the two ray bundles can be thought of as producing two apertures, one for the left and one for the right image.

While circular polarization has been alluded to above, and linear polarization discussed extensively, it is to be understood that the present design may employ circular polarization with certain slightly different components understood by those skilled in the art, such as replacement of linear polarizers with circular polarizers, along with certain minor adjustments, to provide a design in accordance with the present teachings without loss of generality. The present design is therefore not limited to linear polarization, but can provide excellent results when linear polarization is employed as discussed herein.

The present embodiment thus has the extraordinary ability to be of very high brightness and has the result that it closely mimics that which can be output in terms of illumination by using two 35 mm projectors positioned side-by-side for the projection of stereoscopic movies. By actual measurement, this arrangement, when used on an unmodified standard 35 mm projector operating at The Society of Motion Picture and Television Engineers Standard (ANSI/SMPTE 196M-1995) of 16 fL (foot-Lamberts) for a matte screen, will, when projected on a 2.2 gain polarization conserving silver screen, measure at more than 10 fL per eye. Such a measurement results through linear polarizer and eyewear analyzer, and produces more than twice the brightness as the great majority of stereoscopic digital projector installations.

What has been described with respect to this embodiment is a stereoscopic projection system that uses 35 mm film to effectively project an excellent-quality 35 mm stereoscopic image. Unlike the prior subframe arrangement used in the 1980's, it is virtually impossible to improperly assemble projection reels or to make a frameline adjustment error to produce a pseudostereoscopic rather than a stereoscopic image. Said format and projection method can take advantage of all the digital electronic production and post production means, and provides a relatively inexpensive alternative to the present digital projection methods in terms of installation and ongoing costs.

The present embodiment thus includes a system for projecting stereoscopic images. The system comprises a light source configured to provide light energy to a length of film having frames each comprising two sideframes respectively oriented 90 degrees from a preferred viewing orientation, said sideframes oriented with identical or similar-sense rotation, the left sideframe requiring clockwise rotation and the right sideframe requiring clockwise rotation, an image receiving lens configured to receive light energy transmitted through the length of film, and an optical arrangement configured to receive images as light energy from the image receiving lens. An afocal extender both reduces the focal length of the projection lens and moves the refractive optical component's exit pupil toward the rotational component.

Further, the afocal extender not only adjusts focal length in the present design, but also alters the total length of the refractive portion of the optics employed. In many instances, using appropriate lensing as illustrated in an existing projector without the afocal extender, the result can be an unacceptable positioning or co-positioning of optical components. In order to provide an actual physical production product, an afocal extender extends the optical path such that all of the components shown in FIG. 12 can be located with an existing projector. In other words, in practice in an actual projector application, a device such using the teachings of FIG. 12 can physically clear the body of the projector such that the rotation or mirror stage can clear the projector and successfully deliver a high quality stereoscopic image.

The optical arrangement comprises means for reorienting images to the preferred viewing orientation and registering images reoriented to the preferred viewing orientation to a screen. The means for reorienting and registering comprise a plurality of optical refractive elements. The optical arrangement may further include means for polarizing images.

The present embodiment also includes a method for projecting stereoscopic images. The method includes providing light energy through a length of film having frames each comprising two sideframes oriented 90 degrees but similarly oriented to each other from a preferred viewing orientation, receiving light energy transmitted through the length of film at an image receiving lens and transmitting images from the image receiving lens, reorienting images to the preferred viewing orientation, and registering images reoriented to the preferred viewing orientation to a screen using a plurality of optical refractive elements. Polarizing images may also occur, such as after reorienting and registering.

The present embodiment also includes a length of stereoscopic film comprising a plurality of frames, each frame in the length of stereoscopic film comprising a first sideframe comprising a first image, the first image having a preferred viewing orientation, wherein the first image is rotated a predetermined angular amount from the preferred viewing orientation and disposed substantially on the left half of one frame, a second sideframe comprising a second image, the second image also having the preferred viewing orientation, wherein the second image is rotated by the same amount and direction as the first sideframe from the preferred viewing orientation and disposed substantially on the right half of the one frame, and a vertically oriented line separating the first sideframe from the second sideframe. The predetermined angular amount may be, for example, plus ninety degrees on the left and on the right in one embodiment and minus ninety degrees on the left and on the right in another embodiment.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

What is claimed is:

1. A system for projecting stereoscopic images, comprising:
a light source configured to provide light energy to a length of film having frames each comprising two sideframes identically oriented 90 degrees from a preferred viewing orientation;
an image receiving lens configured to receive light energy transmitted through the length of film; and
an optical arrangement configured to receive images as light energy from the image receiving lens, the optical arrangement comprising:
means for reorienting images to the preferred viewing orientation and registering images reoriented to the preferred viewing orientation to a screen, wherein said means for reorienting and registering comprise a plurality of optical refractive elements.

2. The system of claim 1, wherein said optical arrangement further comprises means for linearly polarizing images.

3. The system of claim 2, wherein said means for reorienting and registering received images from the image receiving lens, and the means for linearly polarizing images receive images from the means for reorienting and registering and transmit images toward the screen.

4. A method for projecting stereoscopic images, comprising:
providing light energy through a length of film having frames each comprising two sideframes identically oriented 90 degrees from a preferred viewing orientation;
receiving light energy transmitted through the length of film at an image receiving lens and transmitting images from the image receiving lens;
reorienting images to the preferred viewing orientation; and
registering images reoriented to the preferred viewing orientation to a screen using a plurality of optical refractive elements.

5. The method of claim 4, further comprising linearly polarizing images subsequent to transmitting images from the image receiving lens.

6. The method of claim 5, wherein said linearly polarizing images occurs after reorienting and registering.

7. A length of stereoscopic film comprising a plurality of frames, the length of stereoscopic film configured to be employed in a projection system comprising an image forming stage, a rotation stage, a registration stage, and a polarization stage to provide stereoscopic images in a preferred transmission orientation to a screen, each frame in the length of stereoscopic film comprising:
a first sideframe comprising a first image, the first image having a preferred viewing orientation, wherein the first image is rotated a predetermined angular amount from the preferred viewing orientation and disposed substantially on the left half of one frame;
a second sideframe comprising a second image, the second image also having the preferred viewing orientation, wherein the second image is rotated the predetermined angular amount from the preferred viewing orientation and disposed substantially on the right half of the one frame; and
a vertically oriented line separating the first sideframe from the second sideframe.

8. The length of film of claim 7, wherein the predetermined angular amount is plus 90 degrees.

9. The length of film of claim 7, wherein the predetermined angular amount is minus 90 degrees.

10. A system for projecting stereoscopic images, comprising:
a light source configured to provide light energy toward a length of film having frames each comprising a first subframe oriented 90 degrees from a preferred viewing orientation and a second subframe oriented 180 degrees from the first subframe;
an image receiving lens configured to receive light energy transmitted through the length of film; and
an optical arrangement configured to receive images as light energy from the image receiving lens, the optical arrangement comprising:
means for reorienting images to the preferred viewing orientation and registering images reoriented to the preferred viewing orientation to a screen, wherein said means for reorienting and registering comprise a plurality of optical refractive elements.

11. The system of claim 10, wherein said optical arrangement further comprises means for linearly polarizing images.

12. The system of claim 11, wherein said means for reorienting and registering receives images from the image receiving lens, and the means for linearly polarizing images receive images from the means for reorienting and registering and transmit images toward the screen.

13. The system of claim 10, wherein the means for reorienting and registering comprise a set of orthogonally oriented reflective surfaces.

14. The system of claim 10, wherein said optical arrangement further comprises an afocal extender configured to decrease focal length of the image receiving lens to increase effective image magnification.

15. A method for projecting stereoscopic images, comprising:
providing light energy through a length of film having frames each comprising a first subframe oriented 90 degrees from a preferred viewing orientation and a second subframe oriented 180 degrees from the first subframe;
receiving light energy transmitted through the length of film at an image receiving lens arrangement and transmitting images from the image receiving lens arrangement;
reorienting and altering focus of images to the preferred viewing orientation using an afocal extender; and
registering images reoriented to the preferred viewing orientation to a screen using a plurality of optical refractive elements.

16. The method of claim 15, further comprising linearly polarizing images subsequent to transmitting images from the image receiving lens.

17. The method of claim 16, wherein said linearly polarizing images occurs after reorienting and registering.

18. The method of claim 15, wherein reorienting comprises providing images to orthogonally oriented reflective surfaces.

19. A system for projecting stereoscopic images, comprising:
a light source configured to provide light energy to a length of film having frames each comprising two sideframes in a head-to-head orientation, each sideframe oriented 90 degrees from a preferred viewing orientation;
an image receiving lens configured to receive light energy transmitted through the length of film;
an image receiving afocal extender configured to receive light energy transmitted through the length of film and adjust focal length for the image receiving lens; and
an optical arrangement configured to receive images as light energy from the image receiving afocal extender, wherein the optical arrangement comprises:
means for reorienting images to the preferred viewing orientation and registering images reoriented to the preferred viewing orientation projected onto a screen, wherein the means for reorienting and registering comprise a plurality of optical refractive elements.

20. A system for projecting stereoscopic images, comprising:
a light source configured to provide light energy to a length of film having frames each comprising a first subframe oriented 90 degrees from a preferred viewing orientation and a second subframe aside the first subframe and also oriented 90 degrees from the preferred viewing orientation;
an image receiving lens configured to receive light energy transmitted through the length of film;
an afocal extender configured to receive light energy transmitted through the image receiving lens and decrease focal length of the image receiving lens; and
an optical arrangement configured to receive images as light energy from the afocal extender, the optical arrangement comprising:
means for reorienting images to the preferred viewing orientation and registering images reoriented to the preferred viewing orientation to a screen, wherein said means for reorienting and registering comprise a plurality of optical refractive elements
wherein the afocal extender facilitates providing an optical device comprising the optical arrangement for use with an existing projection device.

21. The system of claim 20, wherein said optical arrangement further comprises a linear polarization arrangement.

22. The system of claim 21, wherein said means for reorienting and registering receives images from the image receiving lens, and the linear polarization arrangement receives images from the means for reorienting and registering and transmit images toward the screen.

23. The system of claim 20, wherein the means for reorienting and registering comprise a set of reflective surfaces.

24. A method for projecting stereoscopic images, comprising:
providing light energy through a length of film having frames each comprising a first subframe oriented 90 degrees from a preferred viewing orientation and a second subframe aside the first subframe and also oriented 90 degrees from the preferred viewing orientation;
receiving light energy transmitted through the length of film at an image receiving lens arrangement and transmitting images from the image receiving lens arrangement;
altering focal length of light energy associated with images received from the image receiving lens arrangement using an afocal extender;
reorienting images to the preferred viewing orientation; and
registering images reoriented to the preferred viewing orientation to a screen using a plurality of optical refractive elements.

25. The method of claim 24, further comprising linearly polarizing images subsequent to transmitting images from the image receiving lens.

26. The method of claim 25, wherein said linearly polarizing images occurs after reorienting and registering.

27. The method of claim 24, wherein reorienting comprises providing images to a plurality of reflective surfaces.

28. The method of claim 24, wherein the afocal extender is dimensioned to facilitate providing a device separate from an existing projector, the separate device configured to perform said reorienting and registering.

29. A system for projecting stereoscopic images, comprising:
a light source configured to provide light energy to a length of film having frames each comprising two sideframes, each sideframe oriented an identical 90 degrees from a preferred viewing orientation;
an image receiving lens configured to receive light energy transmitted through the length of film;
an image receiving afocal extender configured to receive light energy transmitted through the length of film; and
an optical arrangement configured to receive images as light energy from the image receiving afocal extender, wherein the optical arrangement comprises:
a reorienting and registering arrangement configured to reorient images to the preferred viewing orientation and registering images reoriented to the preferred viewing orientation projected onto a screen, wherein the reorienting and registering arrangement comprises a plurality of optical refractive elements.
